(19) United States
(12) Patent Application Publication
(10) Pub. No.: US 2018/0282193 A1
(43) Pub. Date: Oct. 4, 2018

(54) SANITARY LANDFILL LEACHATE TREATMENT PROCESS BY OXYAMMONOLYSIS

(71) Applicant: Vladimir Kudrjawzew, Sao Paulo (BR)

(72) Inventor: Vladimir Kudrjawzew, Sao Paulo (BR)

(21) Appl. No.: 15/944,952

(22) Filed: Apr. 4, 2018

(30) Foreign Application Priority Data
Apr. 4, 2017 (BR) 1020170069079

(51) Int. Cl. C02F 9/00; C05F 11/02; C09K 17/14; C05B 17/00

(52) U.S. Cl. CPC C02F 9/00; C05F 11/02; C02F 1/5245; C05B 17/00; C09K 17/14

(57) ABSTRACT

Sanitary landfill leachate treatment by oxyammonolysis comprises three steps: 1^{st} physical-chemical step with withdrawal of inert solid class II-B, 2^{nd} step of filtration and 3^{rd} step of catalytic oxidation and ammonolysis by cathodic reduction, obtaining treated effluents that complies with environmental legislation in terms of disposal or re-use of water.

This application claims priority benefit to Brazil Application No. 1020170069079, filed Apr. 4, 2017, which is hereby incorporated herein by reference in its entirety.

The present patent of invention for the sanitary landfill leachate treatment process by oxyammonolysis of the physical-chemical effluent, for use in landfills; and the organic nitrogen extracted is used in composts and fertilizers; the final effluent from the treatment undergoes the process of oxidation and ammonolysis, enabling the re-use and/or disposal thereof without harming the environment.

The landfill leachate, popularly known as “slurry”, is the product of the biological degradation of the organic part of the waste deposited in the landfill and contaminated with metals and minerals present in the waste; due to its polluting potential treatment is necessary, and the most common is its dilution with sewage for treatment at the residential sewage plant (ETE).

The landfills having treatment for leachate use biological systems (aerobics and anaerobics), physical-chemical systems (coagulation and flocculation), filtration systems (nanofiltration and reverse osmosis) to comply with environmental legislation, mainly referring to levels of BOD (Biochemical Oxygen Demand), COD (Chemical Oxygen Demand) and the concentration of Ammonium Nitrogen, wherein the federal environmental legislation concerning disposal of treated effluent may change in each state of the nation, this change may only occur in the sense of greater restriction and stricter parameters.

The dilution of the slurry with residential sewage for treatment at the sewage plants presents a number of difficulties: the biological processes employed in the ETEs are not prepared for the high loads of contaminants in the slurry, which requires large dilutions; besides not having the capacity to treat the ionic and metal loads, they are highly sensitive to the recalcitrant loads from the ammonium humates present in the slurry, the concentrations of which contaminate the body of water receiving the effluent from the treatment of the ETE.

The biological processes employed for treating slurry encounter difficulties in the high organic load present in the slurry, in the non-existence of an efficient bacteria for biological treatment, since it is a residue of the biological degradation that occurs in the landfill; although better, the aerobic systems present difficulty in the uniform distribution of oxygen so that there is no proliferation of anaerobic bacteria; additionally, the slurry load varies a lot with the rainfall patterns and the biological systems have major difficulty in monitoring these variations and no biological system is capable of treating the slurry so as to comply with environmental legislation.

When employed for the treatment of slurry the physical-chemical processes present the following difficulties: they are suitable for the suspended solids and have no effect on the dissolved solids and ionic loads present in the slurry; the need to adjust the pH of the slurry for use of the chosen flocculant/clot represents high cost and operational difficulty; the solids withdrawn in the physical-chemical processes leach again when in contact with water hinder the disposal thereof in the landfill.

When employed as treatment for the slurry, direct slurry filtration systems (nanofiltration and reverse osmosis) present the following difficulty: what was filtered, called permeate, does not comply with environmental legislation, in the case of nanofiltration, and both filtration processes present a portion of concentrated retainate, which in the case of reverse osmosis is up to 25% of the original volume of the slurry, and wherein the concentration of contaminants is 400% greater than that of the original slurry; the dispersion of the retainate in the landfill itself does not solve the problem because it leaches and percolates causing an increase in the volume and the concentration of contaminants in the slurry which is normally produced by the landfill, increasing the difficulty in treating the slurry since the contamination is neither withdrawn or transformed into another product, so there is no remedy; normally the concentrate is stored in ponds, but this is now a class I effluent with potentially greater contamination than the original slurry.

Bearing in mind these difficulties and in order to overcome them, the sanitary landfill leachate treatment process was developed by oxyammonolysis of the physical-chemical effluent, the object of the present patent, which consists of providing an economically feasible and environmentally correct treatment of the slurry, and is divided into four consecutive steps; 1^{st} physical-chemical step, which does not require a pH adjustment and whose solid withdrawn is an encapsulated metal chelate other than leached and inert matter; 2^{nd} filtration step, composed of sand filter, microfiltration and nanofiltration, whose retainate is rich in humic substances; 3^{rd} catalytic oxidation step, in which the organic compounds and recalcitrant contaminants present in the permeate of the nanofiltration are oxidized and thereafter the ammonium nitrogen undergoes ammonolysis by cathodic reduction.

The drawings illustrate the equipment involved in the steps of the landfill leachate treatment process, the object of the present patent. The drawings are illustrations that contribute to an improved understanding of the present specification, wherein:

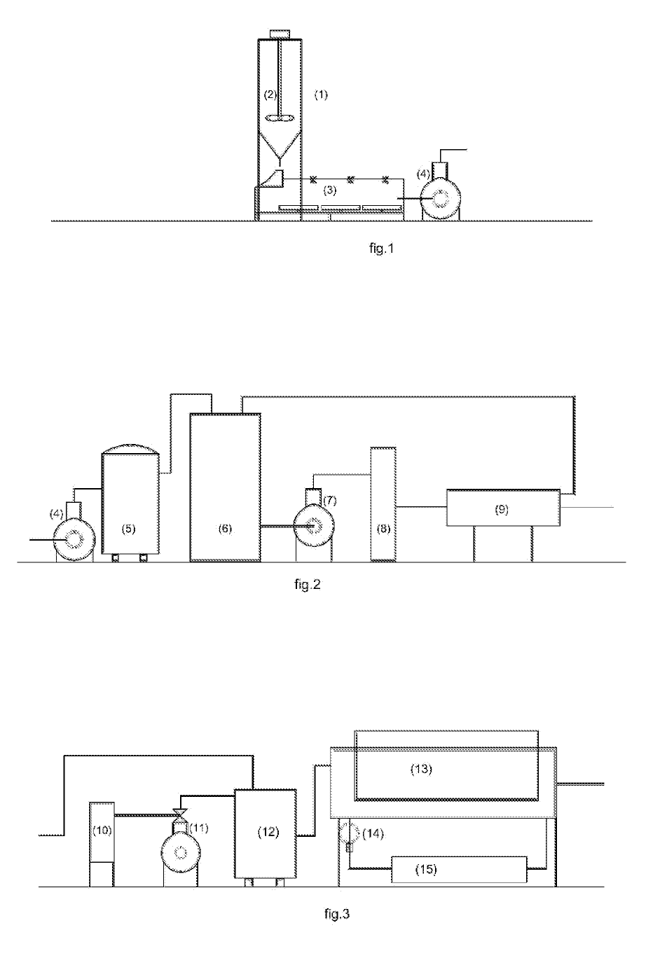

FIG. 1 shows the equipment involved in the 1^{st} physical-chemical step;

FIG. 2 shows the equipment involved in the 2^{nd} filtration step;

FIG. 3 shows the equipment involved in the 3^{rd} step of catalytic oxidation and ammonolysis by cathodic reduction.

The 1^{st} step is physical-chemical and takes place in a physical-chemical reactor (1), endowed with stirrer (2) and uses a property from the humins present in the slurry, originating from the degradation of the lignin present in the waste; the slurry is pumped from the slurry pond to the physical-chemical reactor until it occupies 60% of the volume thereof, adding 0.35% to 0.70%, in volume of such reactor, of ferric chloride (FeCl₃), to be defined by jar-test; Fe′ chelates the humins forming organo-metals which by allosteric effect causes the chelation of other metals present in the slurry and co-adsorption to amine groups forming the clot; FeCl₃ acidifies the mediums which decomposes the carbonates (CO₃²⁻) present, with a large release of carbon gas (CO₂), which causes the formation of a foam that occupies from 20% to 30% of the volume of the physical-chemical reactor; the clot reaction takes place with fast stirring in the medium, 40 rpm on the shaft of the stirrer; after five (5) minutes the flocculation reaction begins by adding 600 ppm to 800 ppm of flocculant anionic polymer, with slow stirring, 20 rpm on the shaft of the stirrer, to prevent rupture of the flakes formed, for three (3) minutes; the flocculant anionic polymer promotes the aggregation of the clots and uptake of oils and grease, suspended solids, etc.; the final size of the flake and the final encapsulation of the contaminant is obtained by adding 600 ppm to 1000 ppm of polyacrylamide cationic flocculant polymer, with slow stirring, 20 rpm on the shaft of the stirrer, for three (3) minutes; the stirrer is switched off and the system rests for forty (40) minutes; due to the formation of carbon gas, the flakes formed float promoting the separation of the medium into two phases, supernatant solids and a gold-yellow colored liquid smelling of ammonium, mainly composed of humates and fulvates having different molecular weights, of ammonium, sodium, iron and chlorides; the physical-chemical reactor is unloaded onto a solid separation ramp, with a grid measuring 0.5 mm, a liquid phase containing the solids under 0.5 mm that falls into the flotation tank by dissolved air (3); the centrifugal pump (4) withdraws the liquid phase from the floater; a scraper withdraws the floated solids, the solid phase of the physical-chemical reactor forms a solid substrate which is taken to a dumpster for final disposal in the landfill itself; the dry solid is class II-B and not leachate.

The 2^{nd} step is that of filtration which involves a quartz sand filter (5) for retaining coarse solids, a microfiltration (8) with polypropylene cartridges and retaining particles greater than 1 micrometer, for protecting the nanofiltration membrane (9); the post-physical-chemical (liquid phase) effluent is withdrawn from the floater by the pump (4) passing through the sand filter (5) and up to the retainate tank (6) of the nanofiltration; a multiple-stage pump (7), having pressure of 1470000 Pa, pumps the effluent to pass through the microfiltration (8) and the nanofiltration membrane (9); the nanoretained matter returns to the retainate tank (6) and the permeate follows on to the effluent treatment step; when the temperature of the permeate at the nanofiltration outlet reaches 40° C., the pressures being maintained, the nanofiltration process will be concluded.

The concentrate from the nanofiltration is rich in humic substances which are solid conditioners for agriculture, humates and ammonium fulvate; the humic and fulvic acids belong to humins and are organic nitrogen compounds having excellent absorption by plants because they originate from the biological degradation of the organic vegetable matter present in the waste deposited in the landfill; by ionic exchange resins the traces of chloride and sodium are withdrawn from the concentrate, which is ready to be used as raw material for producing NPK fertilizer, with the addition of phosphorus (P) and potassium (K) to obtain fertilizer to recover the soils of farmable land.

The 3^{rd} treatment step, in which the effluent permeated in the nanofiltration undergoes catalytic oxidation of the organic matter having lower molecular weight in the aeration tank (13); an ozone generator (11) injects ozone via the venturi circulation pump (12), at the bottom of the tank there are air diffusers and a radial compressor blows the air towards the diffusers; the oxidation consists of the in situ production of oxygen-reactive species (ERO) such as superoxide anion radical (O₂.⁻), hydrogen peroxide (H₂O₂), singlet dioxygen (O₂), hydroxyl radical (HO.), and the effluent receives from 10 g to 20 g of O₃ (ozone) per m³ (cubic meter) of effluent to be oxidized, via venture pump (11), furnished by the ozone generator (10); the oxidized effluent presenting a concentration of Cl⁻ between 1000 mg/l and 2000 mg/l, of Fe³⁺ between 500 mg/l and 1500 mg/l, of Nh₄⁺ between 250 mg/l and 350 mg/l passes through the ammonolysis conduit by cationic reduction.

Ammonolysis by cathodic reduction involves a passage conduit (14), circulation pump (14), press filter (15); a set of electrodes, with graphite cathode and stainless steel anode is mounted inside the conduit and the continuous current source maintains the electric potential difference between 4 volts and 6 volts in the electrodes; ammonolysis is a technique that consists of breaking the nitrogen-hydrogen bonds in the azo groups to increase the valence state of the nitrogen atom up to the formation of molecular nitrogen (N₂), with release of H⁺, acidifying the medium; Fe²⁺ present in the medium acts to inhibit the reaction of nucleophilic addition of chloride in organic compounds; pursuant to the kinetic principles below:

(anode) Cl⁻+H₂O→ClO⁻+2H⁺+2e⁻; Kinetic 1:

(cathode) Fe²⁺+2e⁻→Fe⁰; Kinetic 2:

(decomposition of the ammonium): 3Cl⁻+2NH₄⁺→3Cl⁻+N₂+3H₂O+2H⁺; Kinetic 3:

the electrodes have a power difference of 4 v in continuous current; the cathodic ammonolysis reaction will be interrupted when the concentration of ammonium nitrogen reaches 3 mg/l; during ammonolysis the effluent is pumped to pass through a press filter, in which Fe⁰ hydrate is retained and recovered as ferric chloride by the addition of hydrochloric acid and to be re-used in the 1^{st} physical-chemical step; the effluent of the press filter returns to the ammonolysis conduit.

FIG. 1 illustrates the equipment involved in the 1^{st} physical-chemical step; physical-chemical reactor (1), stirrer (2), flotation tank by dissolved air (3) and pump (4).

FIG. 2 illustrates the equipment involved in the 2^{nd} step of the treatment process, the filtration step; centrifugal pump (4); sand filter (5); retainate tank (6); high pressure centrifugal pump (7); micro filtration (8); nanofiltration (9).

FIG. 3 illustrates the equipment involved in the 3^{rd} catalytic oxidation step and ammonolysis by cathodic reduction; aeration tank (12), ozone generator (10), venture pump (11), ammonolysis conduit (14), circulation pump (15) and press filter (16).

1. “SANITARY LANDFILL LEACHATE TREATMENT PROCESS BY OXYAMMONOLYSIS” comprising the following consecutive steps:
(i) physico-chemical treatment of a slurry, such slurry is inserted into a stirred reactor until 60% of its volume is filled and mixed with ferric chloride from 0.35% to 0.70% by volume of the reactor, said mixture is shaken at 40 rpm for five minutes to coagulate; to the resulting coagulated mixture is added an anionic flocculating polymer, the stirring being maintained at 20 rpm for three minutes, when a cationic flocculating polymer is added and the stirring is maintained at 20 rpm for another three minutes; the resulting mixture rests for forty minutes and is then transferred to a flotation tank by dissolved air;
(ii) filtration of a liquid fraction from the flotation tank in a sand filter, followed by a microfiltration and a nanofiltration resulting in a nanofiltration permeate and a retentate of the nanofiltration;
the sanitary landfill leachate treatment process by oxyammonolysis is characterized by the fact that it further comprises the step of:
(iii) oxyammonolysis wherein the nanofiltration permeate is transferred to an aeration tank and ozone is injected to such tank resulting in an oxidized effluent which is transferred to an ammonolysis conduit where it is subjected to the electric potential difference until reaches the concentration of 3 mg/L of ammonium nitrogen obtaining an effluent, said effluent is then pumped to a press filter for retention of ionic residues, iron and nitrogen.

2. “SANITARY LANDFILL LEACHATE TREATMENT PROCESS BY OXYAMMONOLYSIS”, according to claim 1, characterized in that in the flocculation step of the physico-chemical step is added between 600 ppm and 800 ppm of flocculant anionic polymer.

3. “SANITARY LANDFILL LEACHATE TREATMENT PROCESS BY OXYAMMONOLYSIS”, according to claim 1, characterized in that in the flocculation step of the physico-chemical step is added between 600 ppm and 1000 ppm of polyacrylamide cationic flocculant polymer.

4. “SANITARY LANDFILL LEACHATE TREATMENT PROCESS BY OXYAMMONOLYSIS”, according to claim 1, characterized in that in the microfiltration step particles greater than 1 micrometer are retained.

5. “SANITARY LANDFILL LEACHATE TREATMENT PROCESS BY OXYAMMONOLYSIS”, according to claim 1, characterized in that the retentate from nanofiltration returns to the retainate tank.

6. “SANITARY LANDFILL LEACHATE TREATMENT PROCESS BY OXYAMMONOLYSIS”, according to claim 1, characterized in that the final concentrate of the nanofiltration is raw material for soil conditioners or NPK fertilizer.

7. “SANITARY LANDFILL LEACHATE TREATMENT PROCESS BY OXYAMMONOLYSIS”, according to claim 1, characterized in that the aeration tank receives from 10 g to 20 g of ozone (O₃) per cubic meter (m³) of effluent to be oxidized.

8. “SANITARY LANDFILL LEACHATE TREATMENT PROCESS BY OXYAMMONOLYSIS”, according to claim 1, characterized in that the passage conduit comprises electrodes having graphite cathode and stainless steel anode is mounted inside the conduit and the continuous current source maintains the electric potential difference between 4 volts and 6 volts in the electrodes.

9. “SANITARY LANDFILL LEACHATE TREATMENT PROCESS BY OXYAMMONOLYSIS”, according to claim 1, characterized in that the effluent of the press filter returns to the ammonolysis conduit.
